(19) United States
(12) Patent Application Publication
(10) Pub. No.: US 2008/0235085 A1
(43) Pub. Date: Sep. 25, 2008

(54) VIRTUAL ADVERTISEMENT STORE

(75) Inventors: Matthew Kovinsky, San Francisco, CA (US); Alex Carobus, Los Altos, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/690,668

(22) Filed: Mar. 23, 2007

(51) Int. Cl. G06F 7/06; G06F 17/30; G06Q 30/00

(52) U.S. Cl. 705/14; 707/5; 707/E17.017; 707/E17.107

(57) ABSTRACT

A method is described for obtaining selective criteria for use in selecting one or more advertisements from a plurality of advertisements for display with publisher content, including obtaining selective criteria to be associated with the content, wherein the selective criteria is separate from the content, and wherein the selective criteria is entered by the publisher of the content

### TECHNICAL FIELD

The present invention relates generally to advertising.

### BACKGROUND

As the number of Internet and web users has grown, advertisers have increasingly reached out to the Internet as a channel for advertising. Advertisers may direct advertising to users who are, for example, searching for online information, reading news online or researching product information online. The proliferation of high-speed, high-capacity broadband connections has fueled media-rich, interactive online advertising. Online users may be presented with video or animated advertising that surrounds the information they are consuming, or that “pops up” or “floats over” the web pages they are browsing.

### SUMMARY

Generally described herein are methods for obtaining selective criteria for use in selecting one or more advertisements from a plurality of advertisements for display with publisher content, including obtaining selective criteria to be associated with the content, wherein the selective criteria is separate from the content, and wherein the selective criteria is entered by the publisher of the content. For example, one process incorporates publisher input into the selection and presentation of advertising on a publisher-controlled website.

In one aspect, a method for obtaining selective criteria that may be used in selecting one or more advertisements from a plurality of advertisements for display on a webpage is described that includes obtaining selective criteria to be associated with a webpage, wherein the selective criteria is separate from the content of the webpage, and wherein the selective criteria is entered by the publisher of the webpage. The content of the webpage may include written and visual information present on the webpage as well as formatting information for the webpage, including information present in the formatting information, and other hidden information not used for formatting the webpage. The selective criteria may include a list of words that may be used to match words associated with one or more advertisements, or may include a list of topics that may be used to match topics or categories associated with one or more advertisements, or may include attribute information that may be used to match characteristics associated with one or more advertisements,

In another aspect, a method is described that includes entering information used to select one or more advertisements for display on a webpage, wherein the information is entered by a publisher of the webpage, and wherein the information is stored in a location other than a corresponding webpage for which the information is used. Variously, the information may be entered through a user interface that opens on the webpage of the publisher, or may be entered on a webpage other than the webpage of the publisher, or may be entered through a user interface that appears on a webpage of an organization that provides hosting for the webpage of the publisher. Variously, the information that is entered by the publisher may include a list of words that may be used to select one or more advertisements, or may include one or more topics that may be used to select one or more advertisements, or may include a selection of one or more advertisements from which attribute information is be obtained that is used to select one or more advertisements.

In another aspect, a method of selecting advertisements for display on a webpage is described that includes comparing selective criteria entered by a publisher of a webpage related to a webpage with targeting information for available advertisements, and selecting a set of potential advertisements for display on the webpage. The method may also include providing at least one advertisement from the set of selected advertisements to the webpage, or may include obtaining selective criteria entered by the publisher. The method may also include comparing information concerning the webpage, other than the selective criteria entered by the publisher, with targeting information for available advertisements. The selective information may include a list of words, one or more topics, or a selection of one or more advertisements from which attribute information is obtained that is used to select one or more advertisements.

In another aspect, a method for determining if an advertisement is relevant to a target webpage, including identifying targeting information for the advertisement, obtaining selective criteria entered by the publisher of a target webpage related to the target webpage for the webpage, comparing the targeting information with the selective criteria to determine if a match exists, and determining that the advertisement is relevant to the target webpage if a match exists. The selective criteria may be used to identify one or more selected topics for the target webpage. The method may include analyzing the content of the target webpage to identify a set of one or more webpage topics. The method may include comparing the target information with the identified webpage topics to determine if a match exists. The method may include using meta-information associated with the content of the target webpage to identify one or more topics for the target webpage. Identifying targeting information for the advertisement may include generating a list of topics including analyzing the content of the advertisement.

In another aspect, a method for determining if an advertisement is relevant to a target webpage is described that includes identifying targeting information for the advertisement, obtaining selective criteria entered by the publisher of a target webpage related to the target webpage, analyzing the content of the target webpage to identify a set of one or more webpage topics, comparing the targeting information with the selective criteria and the set of one or more webpage topics to determine if a match exists, and determining that the advertisement is relevant to the target webpage if a match exists.

In another aspect, a method of providing a relevant advertisement to a target webpage is described that includes obtaining selective criteria entered by the publisher of a target webpage related to the target webpage, determining target webpage topics using the selective criteria, identifying advertisements that are associated with the target webpage targets from a set of advertisements, and providing at least one of the identified advertisements to the target website. The method may be conducted in response to a request for an advertisement. The method may also include analyzing the content of the target webpage to identify a set of one or more webpage topics, and determining target webpage topics using the selective criteria and the set of one or more webpage topics. Determining target webpage topics may include using a weighting scheme on the selective criteria and the set of one or more webpage topics. Variously, the selective criteria may include a list of words, one or more topics, or a selection of one or more advertisements from which attribute information is obtained.

In another aspect, an apparatus for determining a relevant advertisement for a target webpage is described that includes a database including advertising content, and a processor configured to determine target webpage topics using selective criteria entered by a publisher of the target webpage and identify advertisements associated with the identified target webpage topics. The apparatus may also include a processor configured to send advertising information from one or more advertisements from the identified advertisements to a target webpage.

In another aspect, an apparatus for determining a relevant advertisement for a target webpage is described that includes means for obtaining selective information entered by a publisher of the target webpage, means for comparing the selective criteria with targeting information from available advertisements, and means for selecting one or more potential advertisements for display on the target webpage. The apparatus may also include means for providing advertising information concerning one or more potential advertisements to the target webpage.

In another aspect, a method of selecting advertisements is described that includes comparing selective criteria entered by a content provider with targeting information for available advertisements, and selecting a set of potential advertisements for use. Variously, the selective criteria entered by a content provider may be associated with a webpage, associated with video content, or associated with audio content.

In another aspect, a method for determining if an advertisement is relevant to provided content is described that includes identifying targeting information for the advertisement, obtaining selective criteria entered by a provider related to the provided content, comparing the targeting information with the selective criteria to determine if a match exists, and determining that the advertisement is relevant to the provided content if a match exists. Variously, the provided content may be a webpage, video content, audio content, or mixed-media content.

In another aspect, a method of providing a relevant advertisement for association with provided content is described that includes obtaining selective criteria entered by a provider related to the provided content, determining target ad topics using the selective criteria, identifying advertisements that are associated with the target ad targets from a set of advertisements, and providing at least one of the identified advertisements for association with the provided content. Variously, the provided content may be a webpage, video content, or audio content.

### DESCRIPTION OF DRAWINGS

FIG. 1 is a block diagram illustration of an example environment in which the selection and presentation of electronic advertising content may be customized including publisher input.

FIG. 2 is a block diagram of an advertisement selection system used in the example environment illustrated in FIG. 1.

FIG. 3 is a flow chart illustrating one method of customizing the content of electronic promotional material on individual uniform resource locators (URLs), domains or properties.

FIG. 4 is a flow chart illustrating an example process associated with the receiving of publisher input regarding advertising topics.

FIG. 5 is a screen shot illustrating an example of a hosted graphical user interface for a publisher to identify product keywords and categories.

FIG. 6 is a screen shot illustrating an example of a nested graphical user interface for a publisher to identify product keywords and categories.

FIG. 7 is a schematic diagram of an example computing system that may be used in connection with computer-implemented methods described in this document.

### DETAILED DESCRIPTION

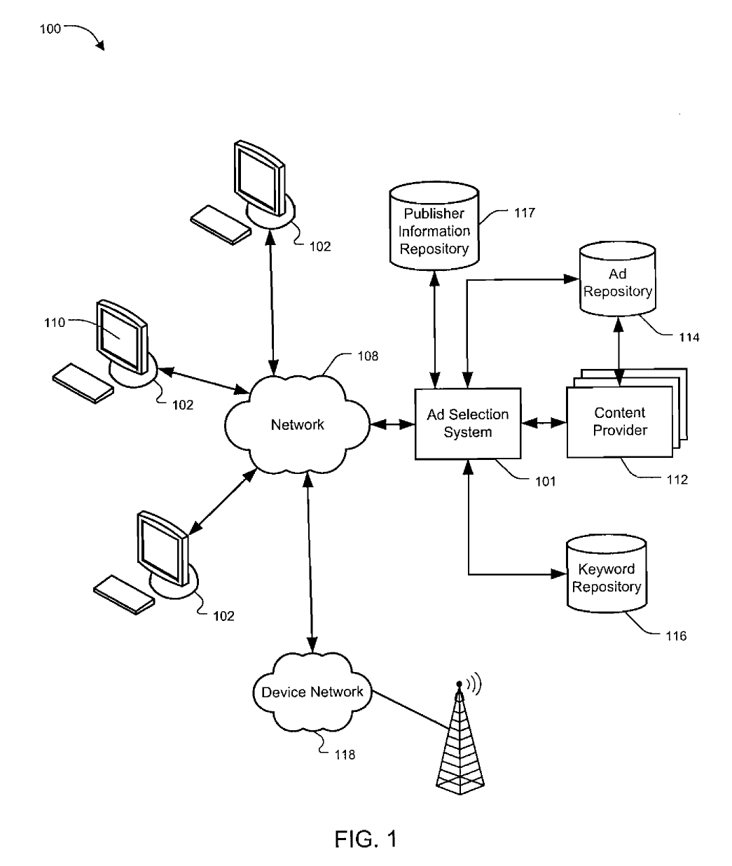

FIG. 1 is a block diagram illustration of an example environment in which the selection and presentation of electronic advertising content may be customized including publisher input.

The environment 100 will be described in reference to an electronic advertisement selection system 101 used to place advertising content “ad content” in websites over the Internet. Advertising content may include text, graphics, video, audio, links, and other web or otherwise related data. Advertisements (“ads”) may be provided to Internet locations (e.g. websites) by the electronic advertisement selection system 101 based in part on input from the publisher of the Internet location. Examples of Internet locations that may be suitable for including publisher input include social networking, business networking, or weblog (blog) sites on the Internet. Other applicable areas may include, but are not limited to, gaming sites, content sharing sites such as music and video sharing sites, or other websites having the capability to display ad content. In general, the environment 100 may provide for additional input in advertisement targeting. For example, the environment 100 may enable publishers of networking or blog sites to have input into the process for selection and population of ad content presented on their websites, or portions of their websites. In addition, the environment 100 may enable publishers of networking or blog sites to exclude certain types of ad content, such as content that may be marked as negative or pornographic in nature, for example. In some implementations, the system 100 may analyze and/or use additional information, such as written and visual information, as well as webpage formatting information, such as meta-information and meta-tags to determine appropriate ad content for the webpage.

As used herein, the term “user” refers to a visitor on a uniform resource locator (URL), domain or property, or other internet location. As used herein, the term “publisher” refers to an owner or content provider of a URL, domain, website, web address property, or other internet location.

In general, the environment 100 may receive input such as selective criteria from the publisher and use the input in matching or selecting ad content available in the system to supply to a location. In particular, the publisher may wish to display a specific product brand, keyword, attribute information, or topic, and may influence the advertisement selection system 101 to supply ads related to the publisher's entered criteria. The publisher may enter input such as selective criteria in various formats. For example, selective criteria input may include a list of words (e.g., keywords), a list of topics, or ad attribute information (e.g., ad type, style product name, etc.). In some implementations, the selective criteria formats may be combined by the publisher. For example, attribute information may be used along with keywords to influence the advertisement selection system 101 to supply related or matching ads. The supplied ad content may be presented to the publisher in a system defined form, such as in a user interface, display device, or other available visual means.

The example environment 100 includes one or more client devices 102, such as a desktop computer, laptop computer, or other computing or electronic device that can access electronic product advertisements via a network 108. Website publishers may access the advertisement selection system 101 to request electronic product advertisement material for presentation in their websites. Specifically, website publishers may use an interface 110 in the client devices 102 to access the advertisement selection system 101 over the network 108.

The advertisement selection system 101 may be coupled with one or more ad repositories 114. The advertisement selection system 101 may send and receive data from one or more ad repositories 114. The ad repository 114 may include advertisements available for display and other ad related information. Examples of other ad related information include costs, scheduling, and inventory data for a particular ad. Since the advertisement selection system 101 has access to one or more data repositories, the system 101 may retrieve advertisements and other ad related information from the repository and present the information to the client device 102. The advertisement selection system 101 may generally access ad content from an ad repository 114 for delivery to a requesting device 102.

The advertisement selection system 101 may be coupled with one or more ad repositories 114. The ad repository 114 may generally receive ad content and other ad related information from a content provider 112. One or more content providers 112 may provide ads and ad related information to the one or more ad repositories 114.

The advertisement selection system 101 may be coupled with one or more keyword repositories 116. The advertisement selection system 101 may send and receive data from one or more keyword repositories 116. The keyword repository 116 includes keywords that may be connected to the advertisements available in the ad repository 114. For example, the ad repository 114 may contain one or more advertisements for a particular product, such as laundry detergent. Each laundry detergent ad may be associated with one or more possible keywords stored in the keyword repository 116 (e.g., soap, detergent, laundry, etc). A content provider 112 may provide information for selecting keywords or may request specific keyword associations for ad content provided to an ad repository 114. The keyword repository 116 may store these keywords and the associated linking information.

In some implementations, the ad repository 114, or other repository, may contain statistical information about what ads have been shown, how often they have been shown, the number of times they have been selected, or who has selected those ads. Although the ad repository 114 and the keyword repository 116 are shown external to the advertisement selection system 101, in some implementations, the advertisement selection system 101 may include one or both systems internally, or a combination of internal and external selection systems and repositories.

The advertisement selection system 101 may also be coupled with a publisher information repository 117. The advertisement selection system 101 may send and receive data from one or more information repositories 117. The publisher information repository 117 may include information that may be used by the advertisement selection system 101 to identify and select ad content. For example, the publisher information repository 117 may include information supplied by a publisher such as demographic information, ad replacement criteria, website properties, backup criteria, hints, scoring criteria, keywords, topics or categories of ad content, examples of a desired type of ad content, or other information. In one implementation, the ad replacement criteria and website properties may be stored to provide the system 101 with information about the type of ad content the publisher may not want. For example, if the publisher of a particular website marks topics, keywords, or attribute information as “negative,” the property may be saved in the publisher information repository 117 and ads related to the “negative” label may not be presented. As another example, if a stored advertisement is marked as negative, the ad selection system 101 may not serve that particular ad to the website having “negative restrictions.”

In one implementation, the publisher information repository 117 may include publisher entered keywords that relate to advertising material. For example, the publisher entered keywords may be used to match stored keywords (e.g., in the keyword repository 116) to provided related ad content. In other words, the publisher entered keywords may be matched to previously stored keywords by the advertisement selection system 101. The selection system 101 may select matching ad content and present the ad content to the publisher. In one implementation, when a request is received for the display of ad content, one or more keywords may be compared to the publisher entered keywords to narrow the search for a particular ad. After the publisher request is fulfilled, the publisher requests may be stored in the keyword repository 116. In one implementation, the stored request may later be used to provide content providers with historical ad selection data.

Website publishers may provide input to the advertisement selection system 101 in various ways. In one implementation, the website publishers may provide a list of words or keywords. In one implementation, the publisher may select advertisements that are of a type, appearance, or character of interest to the publisher. In yet another implementation, the publisher of the website may select categories, topics, or general ad areas of interest to the publisher. As such, a narrow or broad category may be used to select and match advertisement content. In another implementation, environment 100 may be used to allow several members or publishers of a shared website to have specific and directed input into the selection of advertisements displayed on the shared website. In one implementation, upon receiving publisher input, the ad selection system 101 may retrieve content and present the content to the publisher in one or more display formats as examples of potential advertisements that may be displayed later. Generally, the input provided by a publisher may be stored in a publisher information repository 117.

The network 108 connecting client devices 102 to the ad selection system 101 may be of various types. For example, the network 108 may be a private network, internal to a company or organization; the network 108 may be a public network, such as the Internet; or the network 108 may include a combination of public and private networks. The network 108 may be all or a portion of an enterprise or secured network. While illustrated as a single or continuous network, the network 108 may be logically divided into various sub-nets or virtual networks without departing from the scope of this disclosure, so long as at least portion of the network 108 facilitates communications between content providers 112 and at least one client. The network 108 may encompass any internal or external network, networks, sub-network, or combination thereof operable to facilitate communications between various components in environment 100.

In addition to network 108, the environment 100 may include a device network 118 for providing advertisements to other media or devices. For example, the device network 118 may be a mobile device network offering voice and data services to wireless clients. Voice and data services may be provided through the device network 118 that connects to the network 108. In one implementation, a mobile device may connect to the network 108 through the device network 118 and receive ad content provided by the advertisement selection system 101. In one implementation, the device network 118 may be used to find replacement ad content for a particular device.

In general, retrieved content and advertisements may have a format that is appropriate for presentation by a particular type of device, such as a wireless phone (e.g., small display) or a desktop computer (e.g., large display). In this example, the content provider 112 may determine which type of format was requested and may reformat the ad content or advertisement for presentation by the intended device. The reformatted ad may be sent to the publisher for display in their website, via network 108.

Once the ads have been displayed one the device (e.g., in the website), users (visitors) may view the ads in the user interface 110, and may respond to electronic promotional items or ad content. In some implementations, a response from the user, such as clicking or selecting the advertisement may be used to monetize the ad. For example, a provider or a sponsor of the selected ads may be charged for delivery based on a number of instances of the ad actually being delivered (e.g., a number of impressions), or based on a “click-through rate,” or rate at which users respond to the ad. Different ads may support different kinds of user responses to the ad. For example, a desktop computer user may be able to respond to a media-rich browser-based ad by clicking on the ad to activate an embedded link, playing an optional video, filling out a form (possibly after clicking on a link associated with the ad) or making a purchase.

Electronic product advertisements may be formatted for display in a website in several ways. For example, ads may be formatted for display in rectangular frames within a browser page, in skyscraper frames along the edge of a browser page, in horizontal banners across a page, or as “pop-up” or “pop-under” windows that are separate from the browser window from which they were activated. In one implementation, ads may simply be displayed as a selectable text hyperlink. For example, the hyperlink may send the user to another website having ad content related to the selected link. In another implementation, the advertisement may not display fully until hovered over for a specific period of time.

In some implementations, the content providers 112 may distribute additional web content with the suggested product ad content. For example, the ad content may be related to some particular web content, and therefore may be made available with the ad content. The content provided by content providers 112 may include text, graphics, advertisements, sound bytes, and other media from a service provider, such as a news website, or retail website, for example.

Ads may be provided by the system using a variety of approaches and utilizing a variety of information. Related web and ad content may be matched to a search query for information based on specific keywords in the query. As another example, the ad content may be matched to content based on subject matter of the content itself. In either example above, ad content may be selected or retrieved from an advertising repository, such as the advertisement repository 114. Several candidate ads may be matched to particular content, and one or more ads may be ultimately selected based on the user or publisher requesting the ad. In one implementation, ads may be selected based solely on publisher entered information, such as entered publisher selective criteria.

In various implementations, a weighting scheme may be used to determine appropriate ad content for a particular webpage. In general, the weighting scheme may be applied to the webpage components, formatting, or content, as well as any or all publisher entered selective criteria. The weighting scheme may involve emphasizing some aspects of a set of data (e.g., giving them more weight in the final result). In particular, a scoring may be assigned to the components, formatting or selective criteria. For example, the keyword (selective criteria) may be given a 90% weighting score while the formatting of the webpage is given a 10% weighting score. The score may be used with a set of rules to determine appropriate ad content for the webpage. In one implementation, the webpage content may be automatically analyzed by the system 101 to identify one or more webpage topics. Upon determining one or more webpage topics, the system 101 can determine targeted ad content for the webpage. Here, an automatic weighting may be applied when publisher input is not available. As such, the ad selection system 101 may provide suggested advertising based on the webpage content regardless of whether publisher entered selective criteria is available. In some implementations, a similar weighting scheme may be used to determine the advertisements presented to the user of the webpage. In some implementations, a sufficient match between publisher input and ad content may not be found. In this example, the system 101 may reapply a particular weighting scheme to broaden the scope of ad content that may be presented to the publisher. In one implementation, the weighting scheme may be a default weighting scheme using identified topics in the webpage.

Various components of a system that can suggest relevant electronic product ads are now described in detail with reference to the example environment 100 that is shown in FIG. 1. In particular, the system described below may be an ad selection system capable of searching, selecting, and presenting ad content to users or publishers.

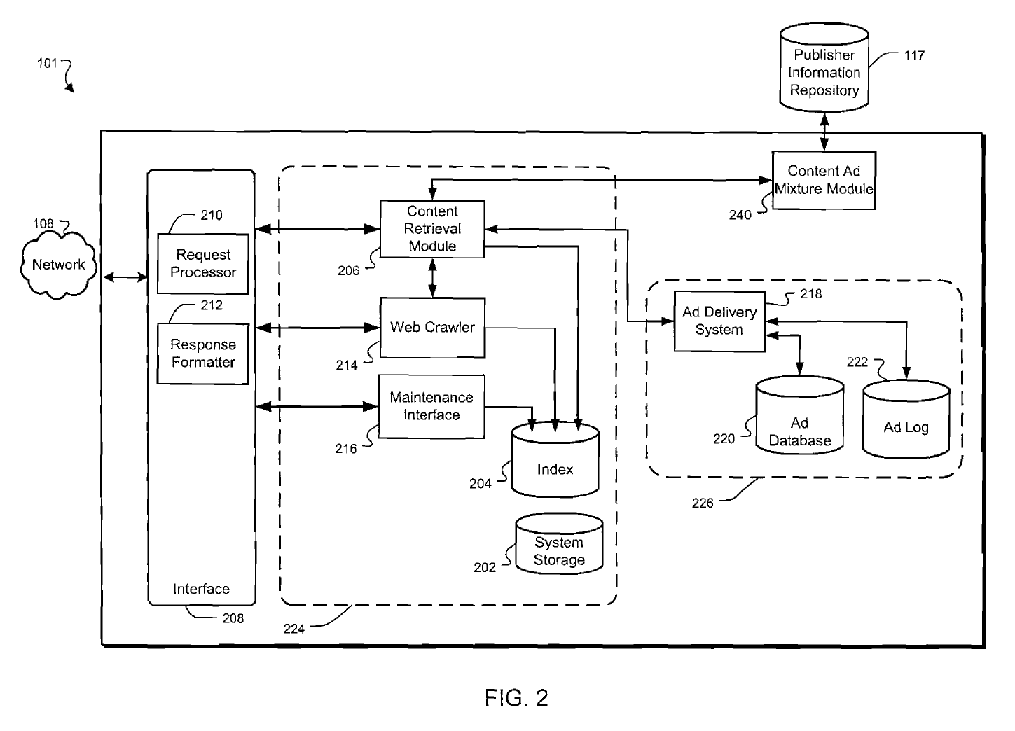

FIG. 2 is a block diagram of an advertisement selection system 101 used in the example environment illustrated in FIG. 1.

As described above, the advertisement selection system 101 may receive a request for ad content from a client device over a network 108. The advertisement selection system 101 may then obtain content responsive to the received request and transmit the responsive content back to the client device for display in a website. In addition, the system 101 may store or index content that users of mobile or nonmobile devices can access. For example, the system may internally store content in a system storage device 202. The system 101 may also index content in an index database 204. The indexed content may be content that is stored in the system storage device 202 or that is stored outside of the system 101. As shown, the system 101 includes a content retrieval module 206 (e.g., a search engine) that accepts requests for content from users of mobile or nonmobile devices and retrieves responsive content, for example from the system storage or from sources external to the system 101, based on entries in the index database 204.

The content retrieval module 206 may be accessed by the system 101 when a user selects a link or visits a particular webpage. For example, the user may select the link, or enter a web address, via an interface 208, which is shown connected to the network 108 in this example. The selection of the link or address entry may initiate a request to retrieve ad content. As such, the content retrieval module 206 may respond to user access or selection of a website with the selection and provision of advertising content to the website. For example, a user of a nonmobile device, such as, for example, a client device, may access the interface 208, which may invoke the content retrieval module 206 to retrieve particular ad content for a particular website. Similarly, a user of a mobile device may access the interface 208, thus invoking the content retrieval module 206 to retrieve particular ad content for a particular website.

As shown, the interface 208 includes a request processor 210 and a response formatter 212. The interface 208 may employ the request processor 210 to format internal requests received from mobile or nonmobile devices. In one implementation, the request processor 210 may parse requests and reformat them from HTML, WML or text format, to search terms or strings that are compatible with the content retrieval module 206. The interface 208 may employ the response formatter 212 to format content that is responsive to received requests. In one implementation, the response formatter 212 may format responsive content and ads in a format like HTML, XML, WML, or some other suitable format, depending on the requesting device. The response formatter 212 may work in conjunction with the interface 208, or it may be part of the interface 208, as shown.

In one implementation, information in the index database 204 may be gathered by an automated information gatherer, such as a web crawler 214 or a spider. The web crawler 214 may, for example, continuously or almost continuously index new information from sources connected to the network 108. The web crawler 214 may also retrieve content in response to a search query (e.g., content external to the system). Some information that is indexed may also be stored (cached) in the system storage 202.

In some implementations, information may be manually loaded in (or retrieved from) the index database 204 or system storage 202 through a maintenance interface 216. In one implementation, the maintenance interface 216 may allow an administrator of the system 101 to manually add bulk data to the index database 204 or to the system storage 202.

The system 101 further includes an ad delivery system 218 with an ad database 220 and an ad log 222. The ad delivery system 218 may receive query requests and other input from the interface 208, via the content retrieval module 206, or directly (direct connection not shown). In some implementations, the ad delivery system 218 may select an ad from the ad database 220 to deliver in conjunction with other content, such as in a response to a query.

In some implementations, the system 101 may include a content ad mixer module 240. The ad mixer module may optionally place a parallel request for publisher information, such as from the publisher information repository 117, when a request is received for ad content data. The ad mixer module request may be sent to a different server (not shown) than the publisher request. In one implementation, the server may be a persistent cache server capable of replication across several datacenters. The persistent cache server may provide fast updates, low latency, and high throughput in the content ad mixer module. In one implementation, requests sent to the persistent cache server may have a specific data format to facilitate categorizing of publisher website information.

In general, the content ad mixer module may send requests having multiple keys for uniform resource locator (URL), property, and domain of the publisher's website. The content ad mixer request may be responded to with the latest settings for each of the requested keys. As such, the content ad mixer may take actions appropriate for the data returned. In one implementation, if a particular key is tied to a request to not view negative ad content, the content ad mixer module may replace ad content that is negative before presenting any ad content. In another implementation, the content ad mixer module may supplement publisher requested ad content with backup criteria, such as when the requested ad content is unavailable. The content ad mixer module may provide information to the publisher. In another implementation, the content ad mixer module may select or deselect ad content meeting defined properties, such as negative, pornography, or other category.

The system 101 shown in FIG. 2 is merely an example, and a system that identifies and customizes ad content may take other forms. In particular, the system 101 may be divided into separate systems to allow for scalability, data integrity or data security. The system 101 may be divided into separate subsystems, each of which is provided by a different company or physical system. In one implementation, content retrieval module 206, web crawler 214, maintenance interface 216, index 204 and system storage 202 may comprise a standalone system 224 that, in conjunction with the interface 208, provides search engine functionality. Similarly, the ad delivery system 218, ad database 220 and ad log 222 may comprise a standalone ad delivery system 226, which may provide ads to a search engine or other content provider. In some implementations, the ads may be provided by a second, standalone content provider 112 (FIG. 1). In some implementations, the ad providers 226 and content providers 112 (FIG. 1) may be the same entity or part of the same system.

In one implementation, the system 101 may be connected to other networks (not shown), such as, for example, an internal company network or a local wireless communication network. The interface may be distributed and may include other interfaces (not shown) that allow various components to exchange, transmit or receive data. The index and/or storage may be local to the system 101 or external to the system and may also be distributed across various physical devices.

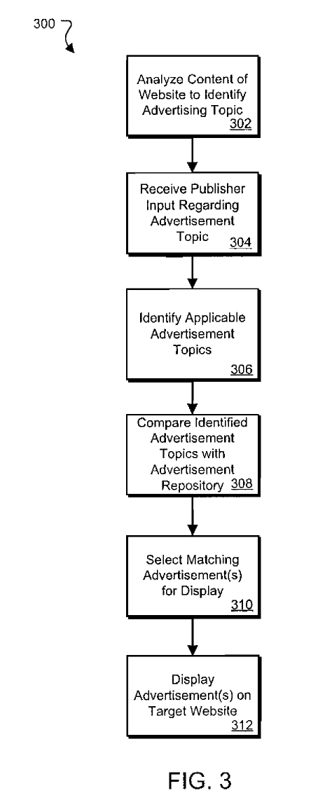

FIG. 3 is a flow chart illustrating one method of customizing the content of electronic promotional material on individual uniform resource locators (URLs), domains or properties.

A method 300 will be described in reference to an electronic advertisement selection system used to place ad content over the Internet. In one implementation, the described method 300 may generally function as part of the advertisement selection system 101. In one implementation, the method 300 may take place at one or more ad content providers where searching, selection, and distribution occur internally. In other implementations, the method 300 may take place over multiple content providers, each performing their own search, selection, and distribution of ad content.

The method 300 begins with an analysis 302 of a publisher's content (e.g., a website) to identify an overall content (e.g., website) topic. The advertisement selection system may perform an analysis of a particular website based on publisher request, automatic or systemic review, based on the request of receiving advertising material on the website, or other instigation. The approach to the analysis may depend on the type of content, as for example, a private website publisher may wish to request an analysis of their website, whereas a business website publisher may wish to have the analysis automatically performed to avoid having to interact with the system.

In one implementation, publisher input, such as an advertising topic, keywords, or other selective criteria, for example, may be received 304 (e.g., in the advertisement selection system 101). The input may be included with the analysis results to influence the identification and selection of ad content.

After the analysis is performed and the optional publisher input is received, a search can be initiated to identify 306 one or more applicable advertisement topics for the publishers' content. In one implementation, a webcrawler in the advertisement selection system may perform a search to identify advertisement topics or keywords that may be relevant to the webpage. In one implementation, the information obtained about a website, such as by a web crawler, may be used to narrow the amount or type of ad content shown to publishers.

Using the identified advertisement topics or publisher entered information, a search can be performed as against available ad content. If the searching yields an advertisement that closely matches the advertisement topics or keywords, the advertisement may be selected 310 for presentation. The selected advertisement may be presented 312 when a user views this particular content (e.g., a webpage).

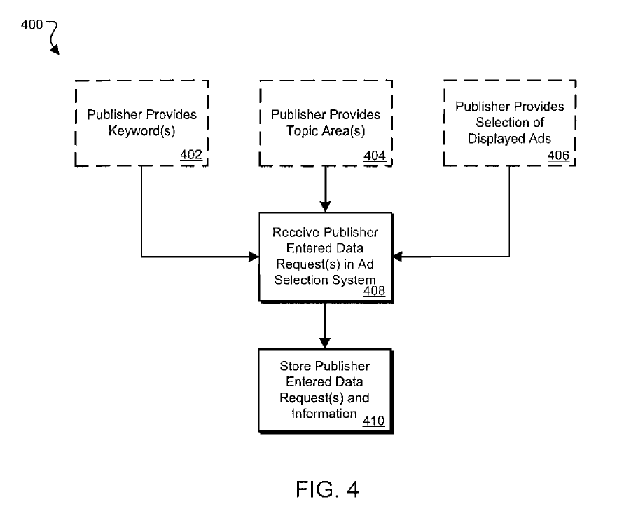

FIG. 4 is a flow chart illustrating an example process associated with the receiving of publisher input regarding advertising topics.

A method 400 will be described in reference to an electronic advertisement selection system that may receive input to select one or more advertisement topics. The input may be provided by website publishers through a website interface, for example. The method 400 begins with receiving one or more types of input (e.g., by the advertisement selection system). The publisher may provide various types of input including selective criteria for use in selecting or matching ad content.

In one implementation, the publisher may provide keywords 402 related to advertisement topics of interest. For example, publishers may use a client device to input information for use by the advertisement selection system. Examples of keywords that may be provided include product keywords, product model names, brands, brand images, or logos which may be used to influence the ad content that may be selected. In one implementation, input information may be provided to the advertisement selection system in the form of a request or search for ad content. User information may be provided in various formats.

In one implementation, the publisher may provide categories or topic areas 404 (e.g., to the advertisement selection system) so as to receive related advertisement content. For example, a social networking publisher who publishes a dating website may wish to display ad content related to dating such as personal advertisements, singles clubs, reuniting services, other dating sites, people searching services, etc. The publisher may enter the topic of dating, and may also enter other possible topics like relationships or other social topics. As another example, the publisher may provide a topic such as entertainment to receive advertisements related to music or television, or advertisements for devices that play music or television shows.

In another implementation, website publishers may be provided with a preconfigured display, such as an “ads like these” display having predefined advertisement examples. The “ads like these” display may be used by the publisher to select ads that the publisher likes or enjoys. The system may use the selected ads to identify or define some criteria for selecting advertisements for the website. As such, the resulting ad display (e.g., to the end user) may be similar to the advertisements selected in the “ads like these” display.

In one implementation, the ad content in the “ads like these” display may be generated by the system 101 using attributes associated with several factors. For example, attributes associated with keywords, topics, formatting, style information, videos, static images, meta-information, interactive information, animated images, text, hyperlinks, forms, scripts, controls and other data that may be used to provide related data for performing an ad content matching process. In some implementations, the attributes above may be used in selecting ad content for the webpage.

In some implementations, the processes 402, 404, and 406 may be optionally performed in the method 400. Furthermore, all or none of the processes 402, 404, and 406 may be performed to carry out the method 400. In addition, publisher input may be received from other sources, and may include other or additional information.

The input from processes 402, 404, 406, or other external input may be received 408 (e.g., in the advertisement selection system). The publisher input may be formatted for use in the advertisement selection system. In various implementations, keywords, topics, and general ad categories may be parsed and analyzed before an advertisement search is created. The publisher input may also be stored 410 as received or after analysis. The stored input may be held until, for example, a website requests the advertisement to be displayed to the user. In some implementations, the input may be stored in another external system. In other implementations, storing the input may be an optional process.

Upon determining that a product advertisement has been requested, a search may be performed to match stored data to current advertisement inventory. For example, the advertisement selection system may perform searches to find ad content using keyword, topic, or attribute data. If suitable matches are found, the advertisement selection system may select the suitable advertisements for presentation to the user.

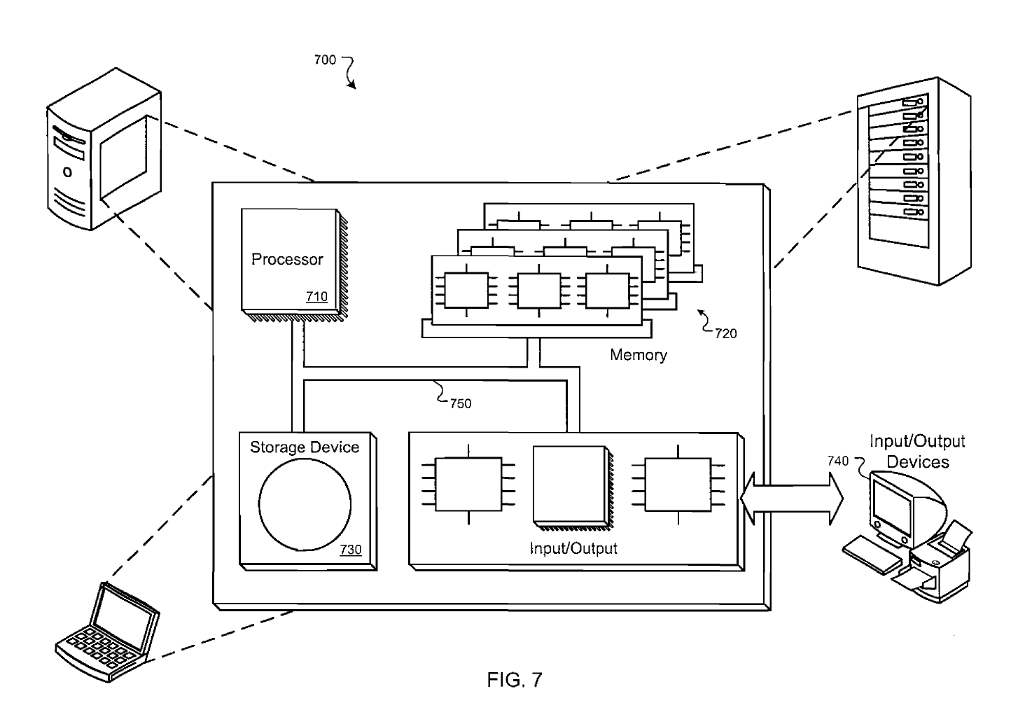

The methods 300-400 may be performed by processing devices, such as those shown in FIG. 7 of this description. The processing devices may be located in a user, publisher, or content providers system. In particular, when processing equipment is used by one of the above methods, the system may select one or more devices, from the system in FIG. 7 or another system, to perform the operations in the methods.

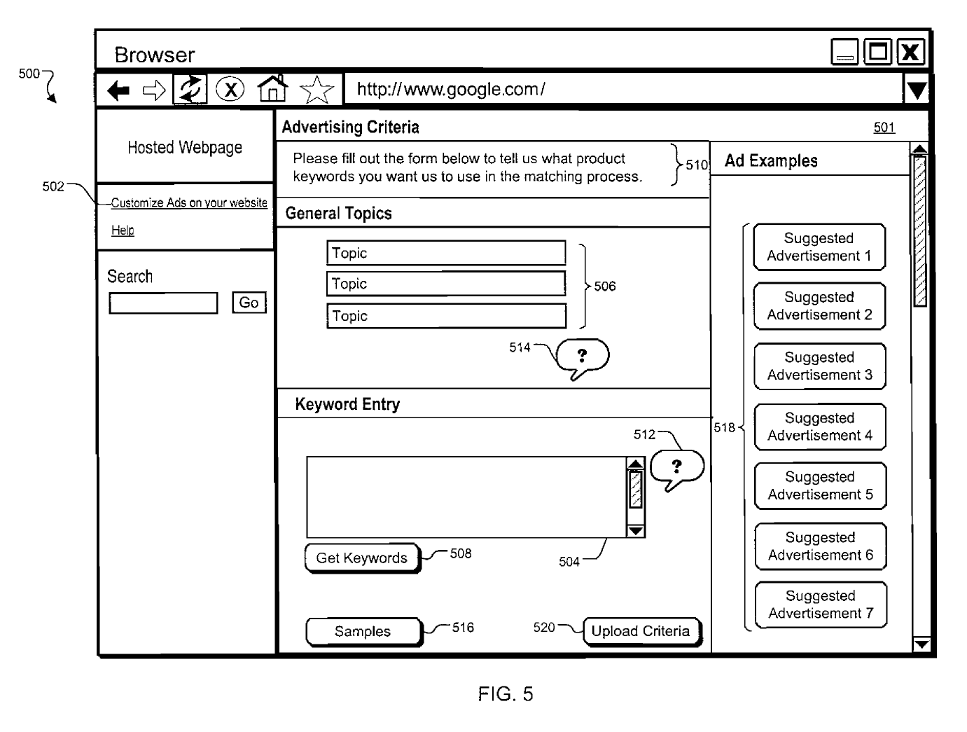

FIG. 5 is a screen shot illustrating an example of a hosted graphical user interface 500 for a publisher to identify product keywords, categories, and “ads like these” selection.

The hosted graphical user interface 500 may be generally resident on a host site (e.g., Google.com). The interface 500 includes an advertising criteria interface 501 that may be accessed when a link 502 is selected from the hosted website, for example. As shown here, the link 502 includes, as an example, the phrase “Customize Ads on your website,” indicating that advertisements for the displayed page may be customized by selecting the link. The link may include any text or graphics to indicate to the user that ad content may be customized. In some implementations, the publisher may access the interface 501 by way of a menu selection or other control in the website. Upon selecting the link, the publisher may view the user interface 501 or another interface available to customize, select, or modify ad content for their website. In some implementations, selection of the link can launch a new browser window having the user interface 501, or other ad selecting user interface.

The user interface 501 may generally include one or more text input fields 504 for accepting publisher input. In particular, the publisher may input product keywords into the input fields 504 to request ad content pertaining to subject matter included in product advertisements. Such requests may include product brand names, model names or numbers, and other keyword type descriptions that may be linked to advertisements available for display in the user interface 501. Publisher input may be entered, for example, one product keyword at a time, separated by commas, vertically in separate data input fields, or by using another method of delineation between multiple input characters or words.

The interface 501 may also include text input fields 506 where general topics or categories may be entered. The publisher may use the text input fields 506 to input general topics, such as electronic entertainment, thus narrowing the focus of advertisements that may be presented. In one implementation, the topics entered may relate to a particular brand of a product. For example, video gaming devices, such as Xbox™ available from Microsoft, may be entered in the text input field 506 to narrow the focus of presented advertisements further. In various implementations, the topics entered may relate to broad categories such as entertainment, health, travel, business, technology, and the like.

In some implementations, publisher input may be cut and pasted from other documents into the input fields 504 or 506, or alternatively may be uploaded from another program, document or file. For example, the publisher may already have a preferred keyword list and wish to upload a previously created list to one or more of their websites. In one implementation the publisher may upload keywords using a “Get Keywords” control 508. The control 508 can launch a file search window (not shown) to search for previously constructed keyword files, for example.

In some implementations, user interface 501 may include contextual text to provide instructions to the publisher. For example, the user interface 501 may include a contextual text 510 such as, “Please fill out the form below to tell us what product keywords you want us to use in the matching process.” In other implementations, the contextual text may provide further information regarding website content such as, “Ads typically appear on the following types of pages (e.g., travel pages, tourist sites).” The publisher may use information in the contextual text to select or input items into the user interface 501. User interface 501 is merely an exemplary interface showing contextual text and as such, additional, less, or different instructions and content may be displayed in the interface 500 or 501.

In some implementations, user interface 501 may include contextual help for further assistance with the interface. In one implementation, free form text box 504 and the text entry controls 506 may include contextual help icons 512, 514 that may be activated, for example, by rolling over the icon. Several contextual help icons may be included in the interface 501. In some implementations, the icons may not appear until a user activates the corresponding control by, for example, rolling over the control, or by performing another selection action. In other implementations, no contextual help icons may be provided.

In some implementations, the user interface 501 may include an “ads like these” display (not shown) where predefined advertisement examples may be displayed to the publisher. In other implementations, advertisement examples may be presented to the publisher based on entered keywords or topics. The “ads like these” display may include several selectable advertisements. The publisher may select some, none, or all of the presented advertising content. As such, selected advertisements may be presented in one or more interfaces for easier viewing. For example, the display may be presented in a sidebar, a webpage, a text link, an image, or other webpage component. In one implementation, the “ads like these” display may be presented in a separate browser window or pop-up window. The publisher may select one or more advertisements in the “ads like these” section. In some implementations, attribute information may be obtained and used to select one or more advertisements for display in the webpage. The selected ads from the “ads like these” section may be identified by the system 101, for example, by matching attribute information obtained from the publisher's website to current ads available. For example, the system 101 may identify appropriate ads using attributes associated with keywords, topics, formatting, style information, videos, static images, meta-information, interactive information, animated images, text, hyperlinks, forms, scripts, controls and other content or webpage data that may be used to provide related data for performing an ad content matching process. The system 101 can store the associated attributes in the publisher information repository 117, for example, to be used in future ad content selection.

In one implementation, the publisher may use the user interface 501 to enter or upload ad selection criteria. Upon entering or uploading the product keywords, topics, or ad areas, the publisher may select a samples control 516 to submit the input to an ad selection system. The system may then perform operations to match the received input data to ad inventory and present matching ad content to the publisher. The ad content presented to the publisher may be actual ads or representative of the actual ad content available for use. This may enable the publisher a preview of likely ads based on the publisher selective criteria or other information entered. In some implementations, and as presented in FIG. 5, the ad content may be displayed alongside the input fields. In other implementations, a new browser window may be launched to display the ad content. As shown in FIG. 5, several example advertisements 518 may be presented in the right hand column. The ads 518 may display a portion of the actual advertisement, such that the publisher has an idea of what product or service is advertised. In general, the number of ads displayed in the interface 501 may be publisher configurable, or may be limited by the number of matches available. The publisher may choose to resubmit keyword or topics to view new suggested ads in the user interface 501. For example, if a publisher does not wish to use any or all of the suggested ads, new keywords or topics may be entered and used to display other suggested ads.

User interface 501 may also include various controls for locating relevant ad content. Additional controls may include keyword popularity searches, cost per click searches, similar site searches, and the like. The publisher may wish to select criteria for specific product advertising as well. For example, a publisher who regularly plays a particular video game may wish to promote that specific game in his website, and may request available ad content related to the video game product.

After viewing the suggested ads, the publisher may select one or more of the ads to view the entire sample ad content. In one implementation, upon finalizing publisher input, the publisher can select an “Upload Criteria” control 520 to upload the selective criteria for advertisement selection. The uploaded selective criteria may be stored in the publisher information repository 117. In some implementations, the publisher can exit the interface without selecting any criteria, such as when none of the presented ad suggestions are of interest to the publisher. The publisher may also modify the keywords and topic content to view more ad suggestions. Ad content may be reconfigured after the content is selected for display on the publisher's website by reentering the user interface 501.

In some implementations, the publisher may perform the ad selection process using a user interface that is displayed as a nested graphical user interface in the publisher's website. For instance, FIG. 5, discussed above, provided the interface 501 in a hosted external website (e.g., Google.com), while the next example illustrates a similar interface provided in the publisher's website.

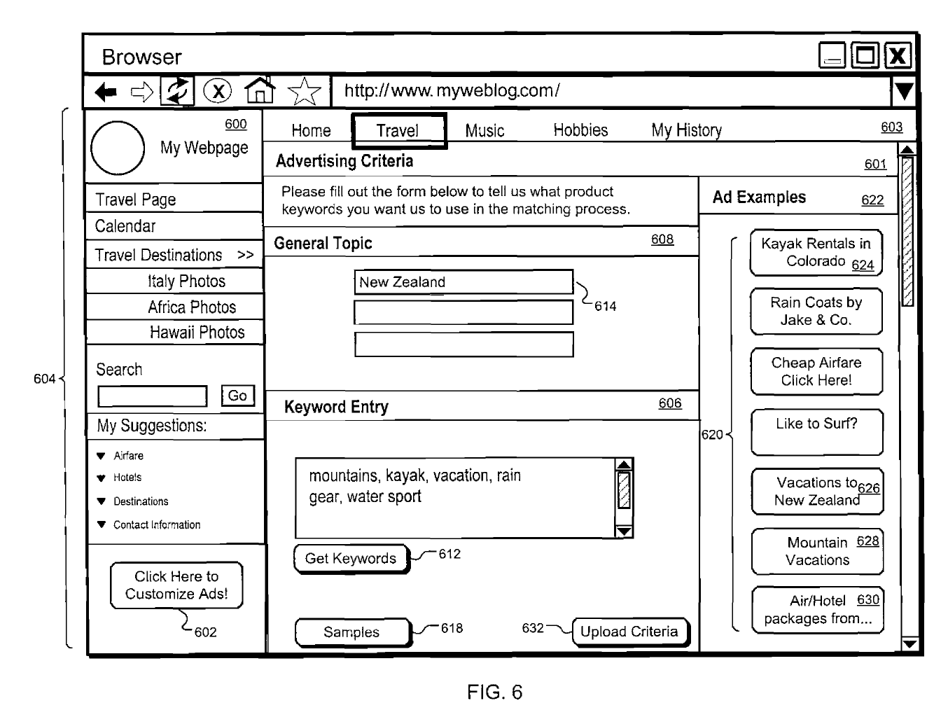

FIG. 6 is a screen shot illustrating an example of a nested graphical user interface for a publisher to identify product keywords and categories.

The nested graphical user interface may generally be nested on a publisher's website 600. The site example shown here is named “myweblog.com.” The nested interface includes an advertising criteria interface 601 that may be accessed when an advertisement, such as a “Click Here to Customize Ads” link 602 is selected from the publisher's website. Other methods of accessing interface 601 are possible.

In some implementations, a nested user interface maybe displayed such that the publisher can easily navigate between the nested interface 601 and the publisher's site. For example, when the publisher is contemplating relevant keywords or categories to enter in the user interface, it may be useful to reassess the website that will host the ad content. Here, a header 603 and a side navigation bar 604 from the publisher's website 600 are displayed, while the ad selection user interface 601 is presented in the main frame. Thus, the user interface 601 may be shown nested within the publisher's website 600.

The user interface 601 may include various sections or areas for entering user input. The sections illustrated in FIG. 6 may include a keyword entry section 606 and a general topics section 608. The publisher may utilize each section independently, or in combination. For example, the publisher here has entered various keywords (e.g., mountains, kayak, vacation, rain gear, water sport) into the keyword section 606. These words may be used by a publisher searching for travel-type ads in a mountainous area, for example. In some implementations, the publisher may have a list of keywords stored in a file on the system. If so, the publisher may select a “Get Keywords” control 612 to upload the keyword list to the interface.

The publisher may also enter input using the general topics section 608. In one implementation, if the publisher wishes to change the scope of presented ad suggestions, one or more topics may be entered in the general topics section 608 and used to enter search criteria. Here, FIG. 6 shows that the publisher has entered “New Zealand” in a text entry box 614, indicating that ads relating to New Zealand may be included in the ad content search.

The various sections (606, 608) of user interface 601 may be presented separately, using different tabs, combined together on one user interface, or using a different presentation. Other sections of the interface are also possible. Furthermore, one or more sections may be displayed to a particular publisher based on experience level or user configuration. In one implementation, if the publisher is an experienced web user, all forms and interfaces for requesting ad content may be made available. Alternatively, one or more forms may be unavailable based on publisher inexperience. In other implementations, additional forms or input boxes or choices may only be available by request or by selecting specified controls.

In other implementations, the publisher may use the user interface 601 to enter or upload ad selection criteria. Upon entering or uploading the product keywords, topics, or ad areas, the publisher may select a samples control 618 to submit the input to an ad selection system. The system may then perform operations to match the received input data to ad inventory and present matching ad content to the publisher. The ad content presented to the publisher may be actual ads or representative of the actual ad content available for use. This may enable the publisher a preview of likely ads based on the publisher selective criteria or other information entered. In some implementations, and as presented in FIG. 6, the ad content may be displayed alongside the input fields. In other implementations, a new browser window may be launched to display the ad content. As shown in FIG. 6, several example advertisements 622 may be presented in the right hand column. The ads 620 may display a portion of the actual advertisement, such that the publisher has an idea of what product or service is advertised. In general, the number of ads displayed in the interface 601 may be publisher configurable, or may be limited by the number of matches available. The publisher may choose to resubmit keyword or topics to view new suggested ads in the user interface 601. For example, if a publisher does not wish to use any or all of the suggested ads, new keywords or topics may be entered and used to display other suggested ads.

Upon entering an input in one or more sections, the publisher may select a samples button 618 to submit the ad search query and view sample advertisements related to the entered keywords, topics, or ad areas. The performed search query may provide the publisher with a list of ad examples 620 in an ad examples section 622. The ad examples 620 may be arranged according to topic, user preference, by section used for the search, or using another arrangement. Accordingly, duplicates may appear in the ad examples list 620. In some implementations, the duplicates may be removed before displaying the ad examples.

The ad examples list 620 may include various advertisements related to the publisher entered input. Publisher entered input may include keywords, topics, product names, phrases, or categories used to find ad content. A particular genre of ad content may be generated from the publisher entered input. As such, ad content may include publisher entered terms because the database was searched using those terms. For example, a “Kayak Rentals in Colorado” ad 624 may have been generated from the keyword search (from the Keyword Entry section 606) since the terms “kayak” and “mountain” were both included in the ad content query. In another example, a “Vacations to New Zealand” ad 626 may have been generated from a combination of the keyword search and the general topic area search. In yet another example, generic travel ads, such as “Mountain Vacations” 628 and “Air/Hotel packages from . . . ” 630 may have been generated from a general ad areas search.

Regardless of how the ad content is organized and presented, the publisher may select an “Upload Criteria” control 632 to upload the selective criteria for selecting ads. Once the ad content criterion is uploaded, the advertisement selection system 101 can use the selective criteria to display one or more ads to the publisher's webpage In various implementations, user selection of one or more displayed ads at a publisher location (such as a website) may generate income for the publisher,

FIG. 7 is a schematic diagram of an example computing system that may be used in connection with computer-implemented methods described in this document.

The system 700 may be used for the operations described in association with any of the computer-implement methods described previously, according to one implementation. Any or all of the client devices 102, content providers 112 or ad selection system 101 may include one or more systems 700, for example. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

Other implementations using a similar system are also possible. For example, a provider of audio or video content (“publisher”) may specify criteria associated with provided audio or video content. An advertising system may then use the selection criteria provided by the publisher in selecting and providing advertising when the associated audio or video content is accessed. For example, when a user selects a video clip for viewing, an advertising selection system may utilize selection criteria associated with that video in selecting and providing advertising. The advertising may run as a lead-in or lead-out to the video selected, or may be provided adjacent to or near a video window, or using another presentation. A similar approach may be taken for audio selections.

In addition, an advertising selection system may be used to associate advertising with provided content in other presentation mediums. For example, an advertising system may utilize publisher entered criteria associated with a block of time on a radio program in selecting and presenting advertisements for on-air playing. A similar approach may be taken for television programs, movies, etc.

The features described may be implemented in digital electronic circuitry, or in computer hardware, firmware, software, or in combinations of them. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

Implementations of the subject matter and the functional operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

### EXAMPLES

### Example 1

In one example implementation, a publisher of a social networking website (weblog), such as MySpace™ (available from MySpace, Inc., Los Angeles, Calif.) publishes content each day for friends and relatives to view. The content generally may include pictures, poems, opinions on products, as well as other things the member enjoys. In this example, an “ads like these” advertising selection architecture may be employed to simplify the advertising selection process for the member/publisher.

An “ads like these” style selection architecture may be selected by the system or the user based on previous input from either the publisher or system, or based on a default setting. The selection may be based, for example, on a level of experience for web design or computer knowledge previously entered. As such, the “ads like these” style is presented to the publisher in this example based on feedback indicating the publisher has little to no experience with computer knowledge or website production. However, the publisher has opinions on products and other things she enjoys including DVDs, CDs, fashion and other novelty items, to name a few examples. Thus, the publisher may be interested in a simple style of selecting interesting or relevant ad content for her “MySpace” website.

In general, the “ads like these” format may be simple to navigate having pre-selected categories to choose from, such as games, music, sports, or hobbies, to name a few examples. In particular, the format can include various predetermined keywords and topics that are presented with checkboxes that a user can select or deselect based upon interests. After selecting various checkboxes, the publisher can submit for samples. Upon completion of the search, example advertisements may be presented to the publisher. Some, all, or none of the presented advertisements may be selected by the publisher as examples of ads that the publisher would like to see. Example ads may be generated based on a predetermined list, or based on an analysis of the publisher website, by topics or keywords entered by the publisher, or another method. The system may determine and store attribute information based on the publisher selection of advertisements. The attribute information may be used to select or match ad content for display in the publisher's website.

### Example 2

In another example implementation, a second publisher may create and manage a webpage that is similar to the example above, but the member/publisher may be a more technically oriented user. Accordingly, this publisher may utilize a topic-based advertising selection architecture to simplify the advertising selection process.

As context, the publisher in this example may spend two to three hours a day online, primarily sending email and learning more about hobbies, such as gardening. In particular, the publisher can publish new found garden knowledge online via a weblog for twenty to thirty relatives, neighbors, and local friends. Some of these may be subscribed members of the gardening weblog. The subscribed members and other visiting users can review the published gardening knowledge and may desire products related to the weblog entries, items discussed, or recommended product.

The publisher may not wish to spend a lengthy amount of time learning an interface for selecting ad content or trying to use pre-existing advanced features that may be available. In addition, the publisher of this weblog may not have the time or interest in optimizing the product advertisements in the gardening weblog for purposes of increasing her earnings. Thus, the publisher may benefit from an advertising selection architecture that includes entering a series of topics or categories. For example, a form may be used that includes one or more fields to enter categories of products that the user would like to have advertised on the gardening weblog. After entering topics, the publisher can submit for samples. Upon completion of the search, example advertisements may be presented to the publisher. If the results are acceptable, the publisher may select and upload criteria to finalize the information and submit to the system.

### Example 3

In another example implementation, a social networking website publisher may regularly update a weblog related to video games. Here, the publisher is a technically savvy user who may spend three or four hours each day online. In addition, the publisher may play video games an additional two hours, thereby making this publisher a signal gamer. This publisher may influence his immediate network of friends, and other visiting users, by the content displayed on his weblog. This publisher may wish to employ advanced advertising selection architecture to maximize the profitability of the video game weblog. For example, the publisher may use advanced tools to customize advertisements presented to maximize earned revenue from the content and readership. The publisher may utilize keywords, selecting and entering specific product categories, brands, models, or other keywords to influence the ad content presented in the weblog. The publisher may also receive example ads if desired, based on the keywords entered. When satisfied, the publisher may upload the criteria to the system for use.

### Example 4

In another example implementation, an individual producing a video or video clip (“publisher”) may desire certain types of advertisements to be associated with the provided video. For example, advertisements may be video advertisements that run as a lead in to the provided video, or may be advertisements that are displayed next to the video as it plays.

The publisher may be fairly sophisticated, and may provide a list of words or topics associated with the video. These words or topics may then be used by an advertising system in selecting and providing advertising content when the video is selected by a user.

What is claimed is:

1. A method for obtaining selective criteria that may be used in selecting one or more advertisements from a plurality of advertisements for display on a webpage, comprising obtaining selective criteria to be associated with a webpage, wherein the selective criteria is separate from the content of the webpage, and wherein the selective criteria is entered by the publisher of the webpage.

2. The method of claim 1, wherein the content of the webpage includes written and visual information present on the webpage as well as formatting information for the webpage, including information present in the formatting information, and other hidden information not used for formatting the webpage.

3. The method of claim 1, wherein the selective criteria comprises a list of words that may be used to match words associated with one or more advertisements.

4. The method of claim 1, wherein the selective criteria comprises a list of topics that may be used to match topics or categories associated with one or more advertisements.

5. The method of claim 1, wherein the selective criteria comprises attribute information that may be used to match characteristics associated with one or more advertisements.

6. A method, comprising:
entering information used to select one or more advertisements for display on a webpage, wherein the information is entered by a publisher of the webpage, and wherein the information is stored in a location other than a corresponding webpage for which the information is used.

7. The method of claim 6, wherein the information is entered through a user interface that opens on the webpage of the publisher.

8. The method of claim 6, wherein the information is entered on a webpage other than the webpage of the publisher.

9. The method of claim 6, wherein the information is entered through a user interface that appears on a webpage of an organization that provides hosting for the webpage of the publisher.

10. The method of claim 6, wherein the information that is entered by the publisher comprises a list of words that may be used to select one or more advertisements.

11. The method of claim 6, wherein the information that is entered by the publisher comprises one or more topics that may be used to select one or more advertisements.

12. The method of claim 6, wherein the information that is entered by the publisher comprises a selection of one or more advertisements from which attribute information is be obtained that is used to select one or more advertisements.

13. A method of selecting advertisements for display on a webpage, comprising:
comparing selective criteria entered by a publisher of a webpage related to a webpage with targeting information for available advertisements; and
selecting a set of potential advertisements for display on the webpage.

14. The method of claim 13, further comprising providing at least one advertisement from the set of selected advertisements to the webpage.

15. The method of claim 13, further comprising obtaining selective criteria entered by the publisher.

16. The method of claim 13, further comprising comparing information concerning the webpage, other than the selective criteria entered by the publisher, with targeting information for available advertisements.

17. The method of claim 13, wherein the selective information comprises a list of words.

18. The method of claim 13, wherein the selective information comprises one or more topics.

19. The method of claim 13, wherein the selective information comprises a selection of one or more advertisements from which attribute information is obtained that is used to select one or more advertisements.

20. A method for determining if an advertisement is relevant to a target webpage, comprising:
identifying targeting information for the advertisement;
obtaining selective criteria entered by the publisher of a target webpage related to the target webpage for the webpage;
comparing the targeting information with the selective criteria to determine if a match exists; and
determining that the advertisement is relevant to the target webpage if a match exists.

21. The method of claim 20, wherein the selective criteria are used to identify one or more selected topics for the target webpage.

22. The method of claim 20, further comprising analyzing the content of the target webpage to identify a set of one or more webpage topics.

23. The method of claim 22, further comprising comparing the target information with the identified webpage topics to determine if a match exists.

24. The method of claim 22, further comprising using meta-information associated with the content of the target webpage to identify one or more topics for the target webpage.

25. The method of claim 20, wherein identifying targeting information for the advertisement comprises generating a list of topics including analyzing the content of the advertisement.

26. A method for determining if an advertisement is relevant to a target webpage, comprising:
identifying targeting information for the advertisement;
obtaining selective criteria entered by the publisher of a target webpage related to the target webpage;
analyzing the content of the target webpage to identify a set of one or more webpage topics;
comparing the targeting information with the selective criteria and the set of one or more webpage topics to determine if a match exists; and
determining that the advertisement is relevant to the target webpage if a match exists.

27. A method of providing a relevant advertisement to a target webpage, comprising:
obtaining selective criteria entered by the publisher of a target webpage related to the target webpage;
determining target webpage topics using the selective criteria;
identifying advertisements that are associated with the target webpage targets from a set of advertisements; and
providing at least one of the identified advertisements to the target website.

28. The method of claim 27, wherein the method is conducted in response to a request for an advertisement.

29. The method of claim 27, further comprising:
analyzing the content of the target webpage to identify a set of one or more webpage topics; and
determining target webpage topics using the selective criteria and the set of one or more webpage topics.

30. The method of claim 29, wherein determining target webpage topics comprises using a weighting scheme on the selective criteria and the set of one or more webpage topics.

31. The method of claim 27, wherein the selective criteria comprises a list of words.

32. The method of claim 27, wherein the selective criteria comprises one or more topics.

33. The method of claim 27, wherein the selective criteria comprises a selection of one or more advertisements from which attribute information is obtained.

34. An apparatus for determining a relevant advertisement for a target webpage, comprising:
a database including advertising content; and
a processor configured to determine target webpage topics using selective criteria entered by a publisher of the target webpage and identify advertisements associated with the identified target webpage topics.

35. The apparatus of claim 24, further comprising a processor configured to send advertising information from one or more advertisements from the identified advertisements to a target webpage.

36. An apparatus for determining a relevant advertisement for a target webpage, comprising:
means for obtaining selective information entered by a publisher of the target webpage;
means for comparing the selective criteria with targeting information from available advertisements; and
means for selecting one or more potential advertisements for display on the target webpage.

37. The apparatus of claim 36, further comprising means for providing advertising information concerning one or more potential advertisements to the target webpage.

38. A method of selecting advertisements, comprising:
comparing selective criteria entered by a content provider with targeting information for available advertisements; and
selecting a set of potential advertisements for use.

39. The method of claim 38, wherein the selective criteria entered by a content provider is associated with a webpage.

40. The method of claim 38, wherein the selective criteria entered by a content provider is associated with video content.

41. The method of claim 38, wherein the selective criteria entered by a content provider is associated with audio content.

42. A method for determining if an advertisement is relevant to provided content, comprising:
identifying targeting information for the advertisement;
obtaining selective criteria entered by a provider related to the provided content;
comparing the targeting information with the selective criteria to determine it a match exists; and
determining that the advertisement is relevant to the provided content if a match exists.

43. The method of claim 42, wherein the provided content is a webpage.

44. The method of claim 42, wherein the provided content is video content.

45. The method of claim 42, wherein the provided content is audio content.

46. A method of providing a relevant advertisement for association with provided content, comprising:
obtaining selective criteria entered by a provider related to the provided content;
determining target ad topics using the selective criteria;
identifying advertisements that are associated with the target ad targets from a set of advertisements; and
providing at least one of the identified advertisements for association with the provided content.

47. The method of claim 46, wherein the provided content is a webpage.

48. The method of claim 46, wherein the provided content is video content.

49. The method of claim 46, wherein the provided content is audio content.

50. The method of claim 46, wherein the provided content is mixed-media content.
